(19) United States
(12) Patent Application Publication
(10) Pub. No.: US 2018/0181986 A1
(43) Pub. Date: Jun. 28, 2018

(54) SOCIAL MEDIA ECOSYSTEM

(71) Applicant: Dreamspace Group, LLC, Davie, FL (US)

(72) Inventors: Robert J. Rapp, Davie, FL (US); Richard A. Rapp, Ridgefield, CT (US); Geralyn G. Green, West Grove, PA (US)

(73) Assignee: Dreamspace Group, LLC, Davie, FL (US)

(21) Appl. No.: 15/882,793

(22) Filed: Jan. 29, 2018

Related U.S. Application Data
(63) Continuation-in-part of application No. 15/205,161, filed on Jul. 8, 2016.

(51) Int. Cl. G06Q 30/02; G06Q 50/00

(52) U.S. Cl. CPC G06Q 30/0251; G06Q 30/0277; G06Q 30/0203; G06Q 50/01

(57) ABSTRACT

A computer implemented method using consumer initiated preferences to increase the advertisement's click through rate.

### CROSS-REFERENCE TO RELATED INVENTIONS

This application is a continuation-in-part of pending application Ser. No. 15/205,161, filed Jul. 8, 2016, which claims the benefit of provisional application No. 62/189,966, filed Jul. 8, 2015.

### BACKGROUND OF THE INVENTION

### Field of the Invention

This invention relates to online document and e-commerce systems and methods.

### Description of the Background Art

With the fast and ever-changing social media, e-commerce and technology environments, the consumer is faced with new ecosystems and applications that greatly influence how their personal information is shared (with and without permission) in the marketplace and how advertising reaches and connects with each consumer.

While consumers are the largest population index on the face of the earth, no invention or economic model empowers the consumer with the absolute control and distribution rights of their personal information. In addition, current platforms provide no advertising strength or purchasing power to the consumers in the marketplace with regards to their personal information.

With the maturity of the internet, and the rapid growth of social media and e-commerce, the advertising marketplace has changed drastically. In 2016, global internet advertising revenues for the first time exceeded the annual spend of traditional TV and print advertising. With new advertising mediums, come non-traditional methods to evaluate their effectiveness and ultimately sales-conversion rates.

Consumers receive much of their social media and e-commerce advertising on an unwarranted basis, while their personal buying searches and purchases are being shared in the marketplace without their permission. When the consumer is searching and buying online, their information is then being sold into the marketplace to other advertisers, suppliers and merchants (collectively, “marketers”).

Presently, online advertising revenues are generated through “click through rates” (CTR), which establish the ratio of how often consumers who see an advertisement click on it. For example, if an advertisement was used 100 times and 5 consumers clicked on it, then the resulting CTR would be 5 percent.

CTRs provide the foundation for online advertising providers to determine their fee structure, as well as their advertising campaigns. The top online advertising providers, Facebook and Google, currently have a CTR of 0.20% and 8.0%, respectively, meaning they are not effectively connecting with their consumers.

In 2016, the global internet advertising spend is greater than $150 billion annually. The advertising marketplace is very fragmented, but two leading companies monopolize most of the industry advertising revenues.

Due to these limitations, marketers continue to be uncomfortable in diversifying their annual adverting spend to other competitive platforms. This is the main reason Google controls about 50% of the global internet advertising market.

Google and Facebook command almost 60% of this entire market.

The Invention takes a 180-degree turn, and takes advantage of the limitations in the current advertising marketplace. By better connecting and aligning the consumer with relevant advertising, CTRs would increase significantly and therefore create greater value in the marketplace, by better delivering advertising campaigns the consumer wants to see.

Therefore, an objective of the Invention is to overcome the inadequacies of the current art devices and provide new solutions to the advancement of advertising art. A 10% market penetration would generate over $15 billion in annual advertising revenues, making it the third (3rd) largest online global advertising provider.

Global interne advertising revenues are mostly generated by online advertising CTRs, which require the consumer to search for products and services of personal interest. The CTR-search engine environment requires the consumer to search for the products or services that meet their personal buying preferences. This search-engine methodology greatly limits the success of CTRs because of the size and scope of the advertising provider market.

Another object of the Invention is to provide an improved computer-implemented method using consumer-initiated preferences to increase the advertisement's CTR, while also providing the consumer with full control of his/her information.

The purpose of advertising is to inform consumers about advertisers' products and services and ultimately persuade the consumers to purchase those products or services. Therefore, the Invention that can best find, align and persuade consumers to buy a company's products or services has a greater value in the marketplace.

Another object of this invention is to provide an improved computer implemented method using consumer initiated preferences to increase the advertisement's CTR.

Therefore, it is an object of this invention to provide an improvement which overcomes the aforementioned inadequacies of the prior art devices and provides an improvement which is a significant contribution to the advancement of the advertising art.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a computer implemented method using consumer initiated preferences to increase the advertisement's CTR.

This Invention comprises a computer-implemented method using consumer-initiated preferences to increase the advertisement's CTR, while creating a central location or digital blueprint of a consumer's future purchasing needs, likes, wants and services (collectively, “personal buying preferences”).

The aggregate of a consumer's personal buying preferences becomes the consumer's “dream or bucket list.”

Consumers will generate and record their personal buying preferences. At some time in the future, those personal buying preferences will be auctioned to the advertising marketplace. This consumer-controlled process will more efficiently match relevant advertising campaigns to the consumer's pre-established interests.

By better matching consumers with more relevant advertising, these advertising campaigns will greatly increase the CTR rates being generated in the marketplace today. This Invention creates a CTR-advertising model not present in the advertising marketplace today.

By substantially increasing CTR rates, the Invention can leverage the economic value and power of having access to better consumer personal buying preferences. It is vital to understand the economic value of consumer information in the global internet advertising market is currently greater than $150 billion annually.

The Invention allows advertising campaigns to better target advertising specifically to the consumer's personal buying preferences, which increases purchase conversion rates (PCR). The goal or end game of any advertising campaign is to generate future product sales with increased PCRs.

By aligning personal buying preferences with relevant advertising campaigns, the Invention creates a unique digital blueprint that can be shared with marketers.

The Invention has three (3) distinct messaging modes: privacy or red (R) status mode, shopping or yellow (Y) status mode, and buying or green (G) status mode.

The Invention's messaging modes is how the consumer electronically communicates their current buying mindset with the marketplace.

In some embodiments, a consumer can indicate a future interest in purchasing a certain personal buying preference or product at an unknown time by labeling it with a predetermined “privacy or red (R) status” mode. For example, a consumer who is thinking about a trip to Italy at some distant time in the future would select “privacy or red (R) status” mode for that trip.

In some embodiments, a consumer can indicate a desire to see advertising or information about a certain personal buying preference or product within a class of products by labeling it with a predetermined “shopping or yellow (Y) status” mode. For example, a consumer who is shopping or looking to purchase a house in New York City would select “shopping or yellow (Y) status” mode for that house.

In some embodiments, a consumer can indicate a desire to now purchase a specific personal buying preference or product within a class of products by labeling it with a predetermined “buying or green (G) status” mode. For example, a consumer who desires to buy a Fossil watch now would select “buying or green (G) status” mode for that watch.

Consumer-Controlled Ecosystem

The Invention is designed to provide the consumer with 100% complete control, power and transparency over his/her specific personal buying preferences and their release and retraction into the marketplace. The Invention allows the consumer to leverage (for his/her own economic benefit) his/her personal buying preferences, rather than allowing third parties to benefit from this information without consumer permission.

A complete consumer-controlled ecosystem means the consumer is directing the marketplace as to what products or services he/she wants to see and when he/she wants to see them. The Invention is designed to force the marketplace to provide the right content, to the right consumer, at the right time.

The Invention's search-engine methodology is the opposite of today's advertising environment and technology platforms

This Invention provides a CTR search-engine environment that requires the marketers (i.e., advertisers and sellers of products) to search for the consumers (i.e., buyers of products) based on their personal buying preferences.

The uniqueness of the Invention is very evident by the consumer's request for advertising information, rather than the consumer's search for advertising information. The Invention's ecosystem puts the onus of the search on the marketers, rather than the consumers. Marketers will have a crystal-clear picture as to what consumers want and when they want it, and can then target relevant advertising to specific consumer-groups that have requested such information.

Changing today's CTR advertising methodologies creates a new and transformational advertising model. Better and more directional advertising will reduce the product/service pricing to—and create economic value for—the consumer.

The Invention allows marketers with the unique ability to customize specific marketing campaigns to specific customer-requests, to direct specialized product messaging to specific consumers.

Improving CTR Percentages

For example, a consumer can indicate a desire to see advertising or information about traveling to Italy within a class of products or services by labeling it with a predetermined “shopping or yellow (Y) status” mode.

The Invention greatly improves advertising CTRs because it generates responses to requests, rather than searches. Consumers are more likely to open or click on advertisements for something they requested to see, rather than something the marketers wanted them to see.

The Invention produces CTRs that are much higher than the current marketplace CTRs.

The Invention's CTRs are responses to the consumers' personal buying preference requests, and not searches.

The internet advertising industry's low CTRs are a direct result of consumers being flooded with endless pages of unsolicited, unwarranted products, services and information, and not connecting with relevant advertising.

Consumers will more likely open or click on more targeted advertising requests from the consumers, more often and more consistently, than consumers searching for information and receiving less targeted advertising.

Consumers and marketers' use of the Invention may substantially increase CTRs—in the range of 30% to 60%—rather than a CTR of 1%. CTR increases in or near this range would be transformational in internet advertising, and would represent extraordinary and unprecedented increases in CTRs. Consumer-requested CTRs would increase exponentially over consumer-searched CTRs.

The Shopping or Yellow (Y) Status Mode—Advertising in Bulk

The Invention creates a new and transformational internet “meeting place,” by better aligning and connecting consumers with marketers. The Invention provides a platform where consumers can aggregate purchasing power and economic benefits for mass advertising in bulk.

The Invention ensures its higher CTRs achieve greater advertising market attention by pooling consumers with similar personal buying preferences with other similar consumers for market scale. Greater scale creates greater purchasing power and economic strength for the consumer.

Marketers' advertising campaigns would rather market to 100,000 interested consumers than 100 interested consumers. Marketers must direct their advertising campaigns and spend where they are receiving the best value for their advertising dollar (“Advertising ROI”).

The power of scale is evident in this example—if an advertising campaign with access to 100,000 interested consumers creates a 5% sales conversion rate, it would generate 5,000 sales, while an advertising campaign with access to only 100 interested consumers and the same conversion rate would generate only 5 sales.

This market scale provides the transparency that enables the marketers to determine its advertising cost, campaigns and price points.

For example, if the Invention notified the marketplace that it had access to only one (1) consumer with a specific interest in Jimmy Choo shoes, the advertising marketplace response might be limited for numerous reasons. However, if the Invention aggregated or pooled 100,000 consumers who were interested in Jimmy Choo shoes, they could leverage their aggregate bulk purchasing power of 100,000 consumers, since marketers would likely offer better prices or deals to win the business of a large percentage of these consumers with similar purchasing needs who would be beneficiaries of that aggregate economic scale.

By locating and aligning 100,000 customers interested in Jimmy Choo shoes, the Invention increases the number of advertising competitors wanting to respond to the consumer requests. By increasing advertising competition, the consumers will always benefit.

Ultimately, the end-game of advertising is to inform the consumers about products and services and ultimately persuade those consumers to purchase those products or services.

Tracking and Measuring Online Advertising

Marketers continue to struggle with aligning, tracking and measuring the success of their advertising dollars flowing to digital and mobile platforms. The Invention better links “online advertising” with “actual offline sales” and thus delivers to the marketers better and more predictable consumer-buying habits and information.

With the Invention, marketers will receive real-time analytics and purchasing conversions not present today from other e-commerce and social media platforms. The Invention uses actual consumer-led information, and therefore avoids the industry-pitfalls associated with consumer data generated through algorithms and data linking-technologies like “cookies” and “atlas” to create usable targeted-marketing models.

The Invention really differentiates after the consumer's “click through rate.”

All other advertisings platforms stop after the “click through rate” because their platforms do not have the capability to direct, control and measure the consumers and any metrics after CTR.

The Invention goes further, in creating what is called a “save through rate” (“STR”). The Invention captures those consumers who have saved the marketer's advertisement directly to their “consumer profile accounts.”

This real-time consumer information is messaged to the marketers that certain advertising campaigns were “saved” to the “consumers' profile accounts”. The marketers are directly notified that these consumers are very interested in their products or services.

The Invention eliminates the tracking problems with linking technologies like cookies, atlas, algorithms or guessing, and instead provides the marketers with direct feedback from the consumers themselves.

For example, if a consumer “requests” to see advertising on Italy, the consumer is likely to see advertising campaigns from marketers about Rome, Florence, Venice and other Italian cities and places. After opening the advertisement by a CTR, and the consumer elects to “save” the Venice advertisement to his/her personal “consumer profile account”—this information would be better than anything in the marketplace today. Now the marketer has the data to better target future communications to that consumer interested in traveling to Venice.

This real-time consumer data can be shared immediately with the marketers, enabling them to receive direct advertising feedback, so they can further strategize how to interact with that customer with future advertising campaigns.

The Invention enables the marketers to better understand the consumers and their specific personal buying preferences, which is not available to marketers today through cookies, atlas and other data-linking technologies.

The Invention subsequently collects consumers with similar “saves” created by the STR interface, and then again pools that information to be presented to marketers in the aggregate.

This interaction or process in the shopping or yellow (Y) status mode enables the consumer to better refine his/her buying preference in each interaction. These interactions also allow the marketers to better refine or change their advertising messages to the consumer.

These consumer-marketer back-and-forth interactions may go on multiple times until the consumer decides to change his/her status mode.

In the consumer-control module, the consumer has the option to change his/her requested buying preferences back to the privacy or red (R) status mode, which would store the “saved” advertising information and messaging in his/her consumer profile account.

The consumer also has the option to delete or terminate all or certain specific advertising received in the shopping or yellow (Y) status mode, or discard permanently individual personal buying preferences from his/her consumer profile account.

In the consumer-control module, the consumer also has the option to change his/her requested buying preferences to the buying or green (G) status mode.

The Buying or Green (G) Status Mode—Purchasing in Bulk

In the buying or green (G) status mode, the consumers can purchase their actual buying preferences, their bucket or dream list. The Invention provides a platform where consumers can increase their purchasing power from “buying in bulk,” as their desired products and services are pooled, aligned and combined with other consumers with similar buying preferences.

The Invention delivers to marketers better and more predictable consumer buying habits and information.

In the buying or green (G) status mode, the consumers are messaging to the marketers that they want to buy and want to start seeing product or service offers from the marketers.

In sum, the Invention creates a new and transformational “buying place,” by better aligning and connecting consumers with marketers who want to purchase specific products.

In this mode, the Invention will begin to ask additional important questions to the consumers, enabling the marketplace to better and more clearly understand what the consumer is interested in buying.

For example, if the consumer is interested in traveling to Italy and now wants to begin receiving offers from the marketplace, the Invention will begin to ask and gather more detailed buying specifics from the consumer.

As an illustration, here are some additional questions that may be asked of the consumer about his/her interest in traveling to Italy.

Are you interested in a cruise—yes or no.

What cities are you interested in seeing—Rome, Venice, Florence, etc.

Are you interested in seeing other countries during your Italian trip—Greece, Spain, Turkey, etc.

How many days are you interested in traveling—3 to 5 days, 5 to 10 days, 10 to 14 days, or more than 14 days.

What months can you travel—June, July, August, etc.

Number of persons traveling—1 to 10 persons, 10 or more persons

These questions are just some of the questions the Invention could ask the consumer. The questions asked will only be structured to enable the marketer to make a qualified and proper offer and to improve the consumer purchasing power to.

The Invention ensures the consumers are leveraging their information to gain aggregate purchasing power by pooling consumers with similar personal buying preferences to gain market scale.

In increasing the consumers' purchasing power, the Invention forces marketers to “bid” against competitors (i.e., other marketers) to win the consumers' business.

For example, one bidding marketer might think providing a 20% discount or a $4,000 offer would win the pooled consumer's business, whereas another marketer might offer a 40% discount or a $3,000 offer to win the consumer's business.

The Invention creates an environment where marketers are bidding against each other, which can only lead to economic benefits for the consumer.

For example, if a consumer individually went to a retail store and wanted to purchase one (1) pair of Jimmy Choo shoes, the consumer would receive a sales price commensurate with the amount of product she is purchasing.

However, if the Invention pooled and aligned 5,000 consumers who wanted to purchase Jimmy Choo shoes, those 5,000 pooled consumers would be the beneficiaries of aggregate economic scale.

In addition, by locating and aligning 5,000 buying customers interested in Jimmy Choo shoes, the invention increases the number of competitors wanting to respond to the consumers' requests.

By locating, aligning and providing marketers with consumers ready to purchase, the Invention saves the marketers a lot of money, and enables the marketers to provide volume discounts commensurate with aggregate scale.

The Invention gets marketers closer to the consumers than any other platform. As a result, the Invention can better track and measure the relationship between “online advertising” and “actual online and offline sales”.

With other platforms, the marketplace often just doesn't know if a consumer saw an internet advertisement and then purchased their product online or in a retail store as result of that advertisement.

The Invention eliminates the limitations associated with online advertising and sales conversion metrics.

At the end of this process, the consumer profile account is updated accordingly and saved for future reference.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which.

FIG. 1 is an overview of the consumer account setup and personal profile, where the Invention controls the interfacing with the marketplace.

FIG. 2 is a flow chart illustrating logical processing steps for setting up an electronic auction for the consumer to see requested product or service preference “advertising” according to the Invention.

FIG. 3 is a flow chart illustrating logical processing steps for setting up an electronic auction for the consumer to see requested product or service “offers” according to the Invention.

FIG. 4 is a flow chart illustrating logical processing steps for the consumer processing an accepted offer according to the Invention.

FIG. 5 is a flow chart illustrating logical processing steps for the consumer setting up an electronic blueprint of his/her personal buying preferences by specified categories according to the Invention.

FIG. 6 is a flow chart illustrating logical processing steps for the consumer setting up an electronic auction by pooling consumers of similar or like product or service preferences for advertising according to the Invention.

FIG. 7 is a flow chart illustrating logical processing steps for the consumer setting up an electronic auction by aligning consumers (by numerical count) of similar or like product or service preferences for advertising according to the Invention.

FIG. 8 is a flow chart illustrating logical processing steps for the consumer setting up an electronic auction by aligning consumers (by numerical count) of similar or like product or service preferences to be openly shared with the marketplace according to the Invention.

FIG. 9 is a flow chart illustrating logical processing steps for the consumer setting up an electronic auction by pooling consumers of similar or like product or service preferences for marketplace “offers” according to the Invention.

FIG. 10 is a flow chart illustrating logical processing steps for the consumer setting up an electronic auction by aligning consumers (by numerical count) of similar or like product or service preferences for marketplace “offers” according to the Invention.

FIG. 11 is a flow chart illustrating logical processing steps for the consumer setting up an electronic auction by aligning consumers (by numerical count) of similar or like product or service preferences to be openly shared with the marketplace “offers” according to the Invention.

FIG. 12 is a flow chart illustrating the consumer's detailed product preference, in a funnel format, which details at the top of the funnel the consumer's broad product preferences (e.g., shoes) and, as the funnel narrows in width, the consumer's product features and specifics get more defined or specific (e.g., Allen Edmonds shoes).

FIG. 13 is a flow chart illustrating the consumer's detailed product preference, in a funnel format, which details at the top of the funnel the consumer's broad product preferences (e.g., shoes) and, as the funnel narrows in width (towards the bottom of the funnel), the consumer's product features and specifics get more defined (e.g., Allen Edmonds shoes).

### DETAILED DESCRIPTION OF THE PREFERRED EMBODIMENT

An online user has his own personal webpage which allows him to display which products he may want to purchase in the future. The level of interest is displayed with a corresponding color which the user uses to label the product. For instance, the color green is associated with the user wanting to immediately purchase a certain product, whereas the color red means that the user is somewhat interested in the product, but will most likely not purchase it in the near future. These products with attached colors are communicated to the online advertisers, who will then bid on the right to advertise to that specific user, thereby enabling the online advertiser to show the user the relevant advertisement.

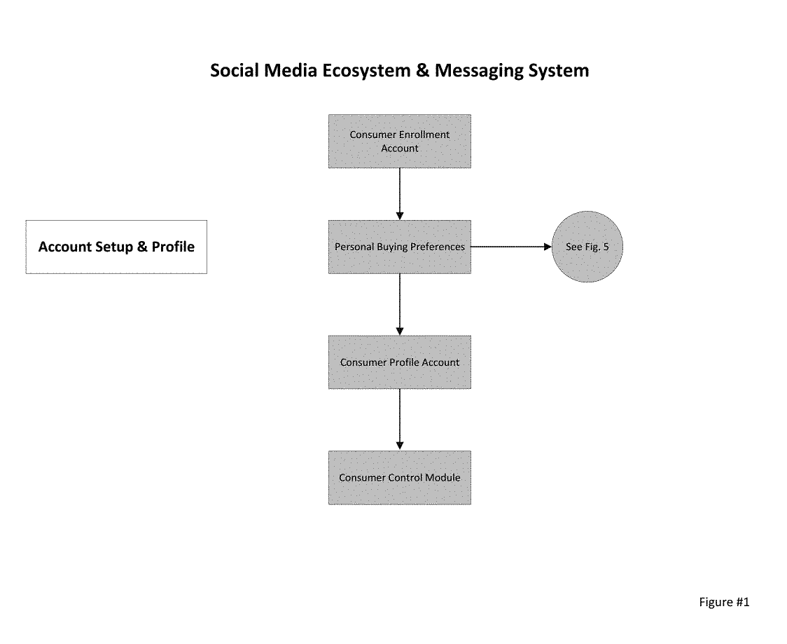

FIG. 1—Consumer Enrollment Account

The Invention provides a computerized electronic interface and method for consumers to create and update their information real-time through remote terminals, such as personal computers, tablets, PDAs, cellular phones, etc., via an electronic network, such as the internet.

The Invention's consumer-enrollment account includes several fields for the consumer to enter identifying information, such as first name, last name, date of birth, address, mailing address, home phone number, cell phone number, email address, preferred method of contact, etc.

At the enrollment-account interface, the consumer would also set up any credit card information needed for future transactions. The credit card information would only be released to the marketer if a sale transaction was consummated.

The enrollment interface also creates a method for the consumer to enter an enrollment-account username. The username would also require the registration of a password for security purposes. The username and password will be used to uniquely identify each consumer with his/her specific personal buying preferences, which would create their unique digital blueprint in the Invention for the marketplace.

While accessing the consumer-enrollment interface, the consumers will have access to a tutorial to help them better understand and use the Invention to maximize the consumers' benefits and purchasing power.

FIG. 1—Personal Buying Preferences

Once the consumer-enrollment account process is complete, consumers can electronically start building their personal buying preferences. Consumers in the buying preference interface begin sharing their future buying habit information in an electronic blueprint format.

The Invention's logical processing steps are designed to help consumers find, align and purchase their future purchasing needs, wants and likes (also known as the consumer's “dream or bucket list products or services”).

The personal buying-preference interface creates an electronic consumer blueprint, which allows the Invention to interact and process internally, to more effectively connect with market interfaces and networks.

In the personal buying-preference interface, the Invention only allows the consumer initially to enter his/her personal buying preferences in the privacy or red (R) status mode, to better protect the confidentially of the consumer's entered information. The privacy or red (R) mode means all product or service preferences are process-protected and are never shared into the marketplace, unless electronically modified by the consumer to another status mode.

The Invention provides the consumer in the personal-buying preference interface access to five (5) categories to input the consumer's dream or bucket list of products and services.

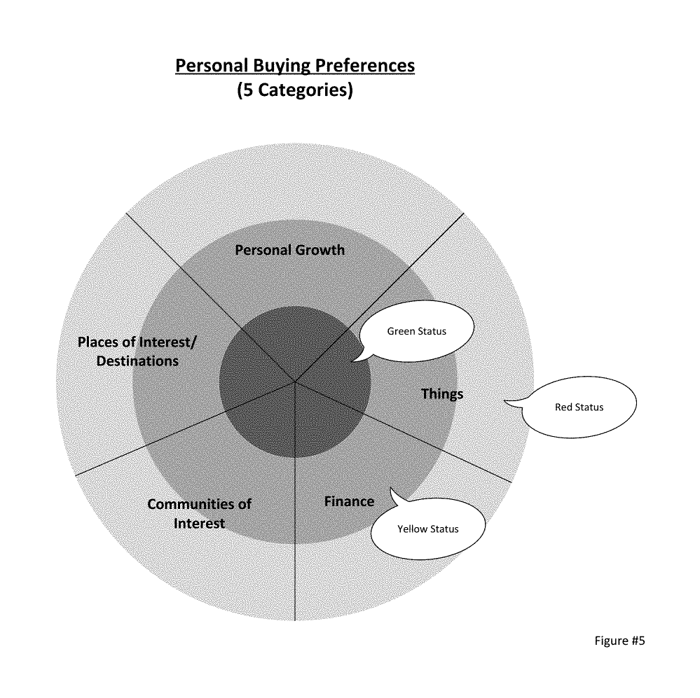

FIG. 5 illustrates the five (5) personal buying preferences or categories of (i) personal growth, (ii) places of interest or destinations, (iii) things, (iv) finance and (v) communities of interest.

Category number 1 is “personal growth.” This category allows the consumer to enter items related to dream products or services like: education, home ownership, renting, health, fitness, cosmetic surgery, career goals and objectives, etc.

Category number 2 is “places of interest or destinations.” This category allows the consumer to enter items related to dream products or services like: travel, hotels, airfare, transportation, tours, cruises, etc.

Category number 3 is “things.” This category allows the consumer to enter items related to dream products like: automobiles, boats, motorcycles, electronics, telephones, watches, shoes, jewelry, home improvements, interior design, televisions, etc.

Category number 4 is “finance—cash savings.” This category allows the consumer to enter items related to dream products or services like: insurance, credit cards, mortgages, investments, etc.

Category number 5 is “communities of interest.” This category allows the consumer to enter items related to dream products or services like: charities, art, books/authors, common activities, clubs and associations, etc.

As personal buying preferences are entered into any of the aforementioned five (5) categories, the Invention simultaneously saves and stores the processed information into the consumer-profile account.

The consumers will spend much of their time updating, changing and providing greater details to their personal buying preferences in this portion of the Invention's application.

In this application, the consumers over time will begin to shape their personal buying preferences in greater detail. The Invention helps the consumer transition from summary-based product or service preferences (e.g., shoes) to more detailed product features and specifics (e.g., Allen Edmonds shoes, men's shoes, dress shoes, loafers, brown, size 11).

The Invention takes the consumers through logical processes to help the consumers better define and secure the advertising and product or service offers they requested to see.

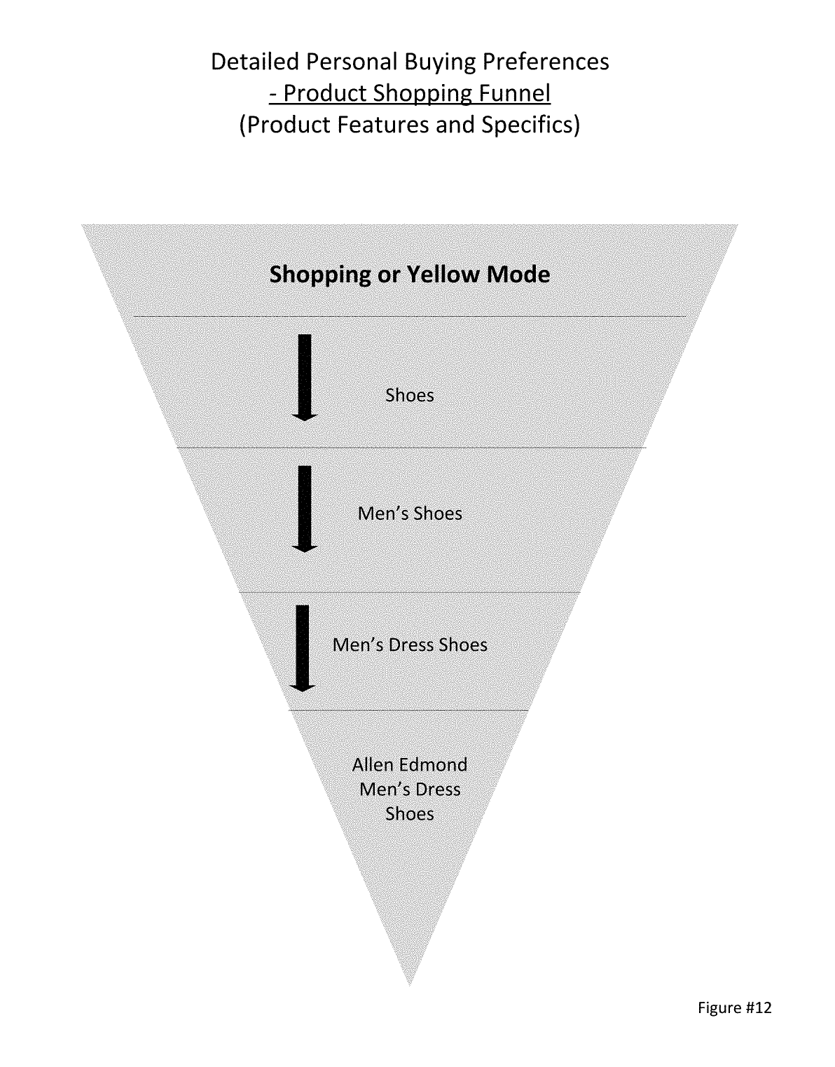

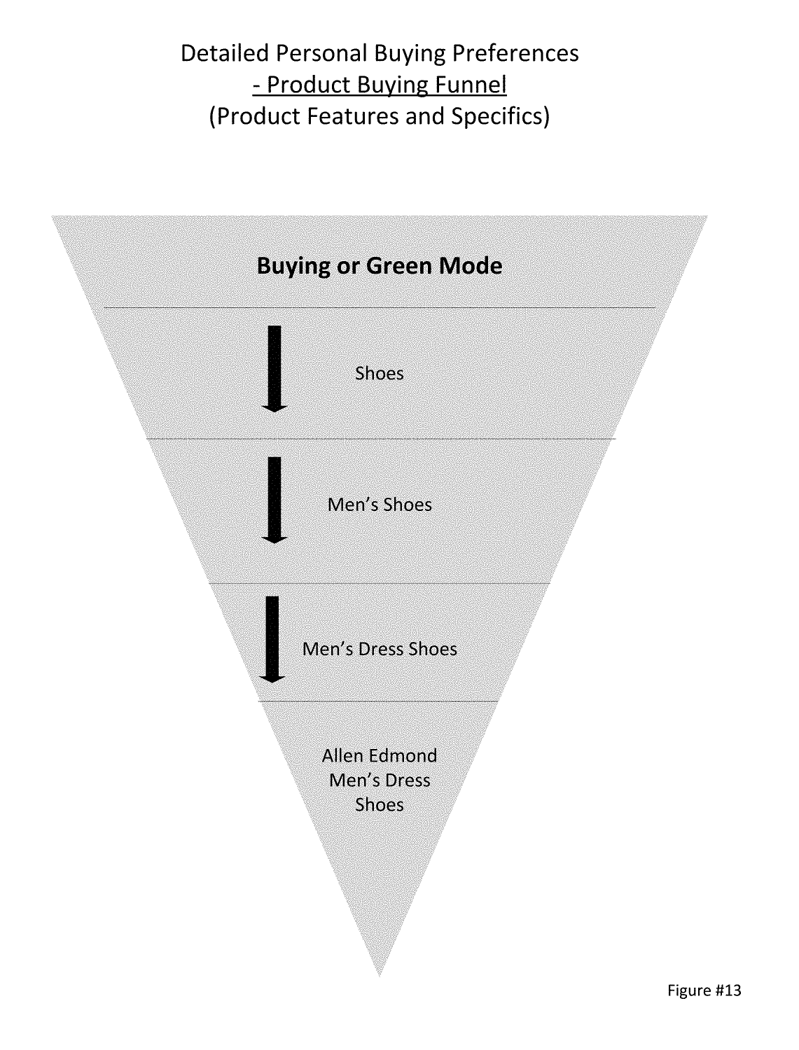

For example, as illustrated in FIG. 12 and FIG. 13, the Invention's logical interfacing and processing would look something like this for a pair of shoes.

I am interested in shoes (summary preference)

I am interested in men's shoes (detailed preference)

I am interest in men's dress shoes (detailed preference)

I am interested in “Allen Edmonds” men's dress shoes (detailed preference)

Below is additional Invention information not shown in FIG. 12 and FIG. 13.

I am interested in “Allen Edmonds” men's dress shoes, loafers (detailed preference)

I am interested in “Allen Edmonds” men's dress shoes, loafers, brown (detailed preference)

I am interested in “Allen Edmonds” men's dress shoes, loafers, brown, size 11 (detailed preference)

This transparency allows the consumer to see advertising and product or service offers on many product or service levels, all controlled by the consumer.

The personal buying-preference module is where the consumers provide the needed direction and transparency to drive marketplace requests that meet their detailed product requests. As the consumers better define their product or service requests in the marketplace, marketers have a better opportunity to deliver more relevant and focused advertising and product or service offers.

FIG. 1—Consumer Profile Account

The consumer-profile account interface is where all the consumer-personal buying preference information is saved and stored. This consumer-profile account is updated every time the consumer has a status update to the privacy, shopping or buying mode.

If the consumer deletes profile information, that information is deleted in his/her interface process.

In the consumer-profile account, the Invention monitors and records all historical updates to the consumer's personal buying preferences. Using historical data information, the Invention can provide the marketplace with detailed information not available with other systems.

For example, the Invention can provide marketers with unique industry data points, such as:

How long did the consumer stay in the shopping or yellow (Y) mode status before moving to a buying or green (G) status mode?

What is the consumer's buying conversion percentage (%), which determines how many times the consumer purchases a product or service after changing to a buying or green (G) status mode?

How many marketer advertisements does a consumer see before he/she actual purchases a product or service from his/her personal buying preference list?

The consumer-profile account provides the consumer with a real-time updated inventory of personal buying preferences that the consumer is interested in buying (privacy or red (R) mode), looking to buy (shopping or yellow (Y) mode), wanting to buy (buying or green (G) mode) and what Items they have already purchased (historical purchase records) in history or record mode.

The consumers, at any time, can reference and see the status of any personal buying preference on their lists.

FIG. 1—Consumer Control Module

The consumer-control module is the interaction module where the consumers can change the status mode of their personal buying preferences to privacy (red (R)), shopping (yellow (Y)) or buying (green (G)).

This module is where the consumers actively change the status mode to their listed personal buying preferences. This module controls the delivery interaction of information into the marketplace, which is 100% controlled by the consumers.

Upon the consumer meeting the proper consumer-user and security codes in the consumer-control module, the consumer can move a product or service preference item to a privacy or red (R) status, to a shopping or yellow (Y) status, and then to a green status, and vice versa, interchangeably between these status modes, as often and as frequently as he/she wishes.

This module is designed to empower the consumers with 100% complete control, power and transparency over their specific personal buying preferences, and this information's release and suppression into the marketplace.

The following messaging modes are available in the consumer-control module:

Privacy or Red (R) Status Mode

In the privacy or red (R) status mode, the consumer does not wish to share certain or individual buying preferences with the marketplace. Therefore, the Invention will secure and not share any specific personal buying preferences electronically coded with a privacy or red (R) status mode with any marketers.

The Invention in the consumer-control module provides the tracking of interactions and changes of information for reporting purposes.

For example, the Invention will determine the average number of days that a specific consumer goes from a privacy or red (R) status mode to a shopping or yellow (Y) status mode, or a Shopping or yellow (Y) status mode to a buying or green (G) status mode (i.e., consumer acceptance or conversion to a sale).

To protect the consumer's privacy, a consumer can change to a privacy or red (R) status mode at any time. A consumer may change to privacy or red (R) status mode for any number of reasons, including (i) he/she already purchased the product or service, (ii) he/she is no longer interested in the product or service, (iii) his/her timeframe for purchasing that specific product or service has changed, and (iv) for any and all other reasons (or no reasons), entirely within the control of the consumer.

In the privacy or red (R) status mode, the consumer will not receive any unwanted advertisements and offers from marketers.

This privacy or red (R) status mode also benefits the marketplace since marketers can focus their advertising and marketing efforts on consumers who are currently interested in purchasing their products or services.

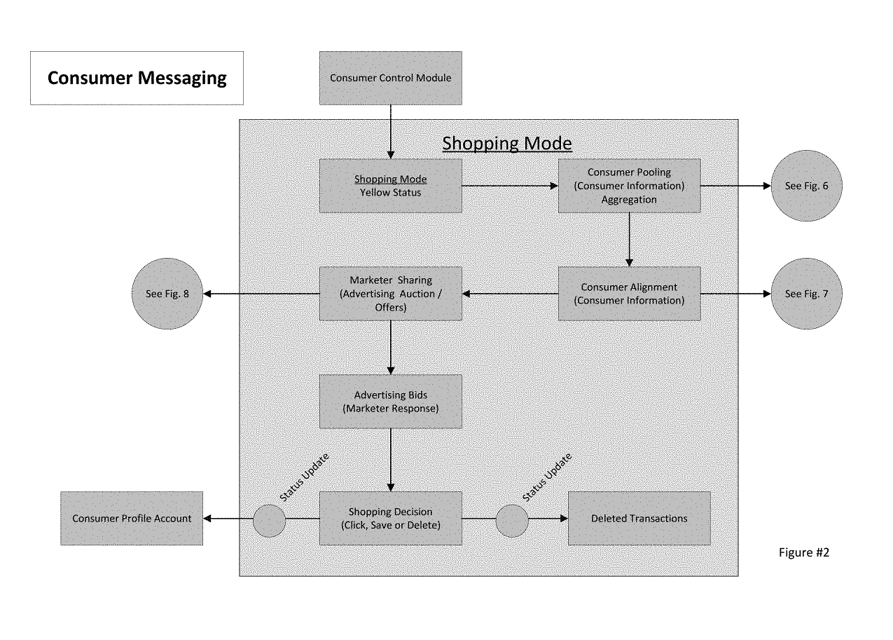

FIG. 2—Shopping or Yellow (Y) Status Mode

In the shopping or yellow (Y) mode, the consumer is now interested in shopping for his/her desired buying preference.

The Invention provides the consumer's electronic permission to the marketplace that the he/she wants to see advertisements to learn more about a specific personal buying preference item on his/her dream or bucket list.

In the shopping or yellow (Y) status mode, the consumer will begin to receive requested or wanted advertisements from marketers.

Once the consumer electronically sets a shopping or yellow (Y) status mode, that consumer information is electronically sent to the Invention's consumer pooling module.

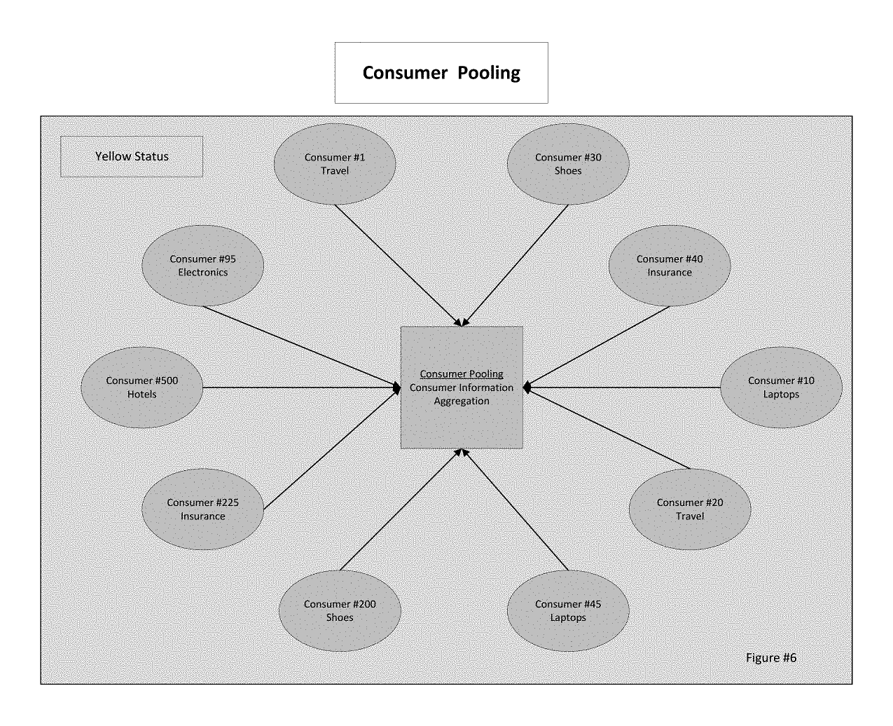

FIG. 6—Consumer Pooling Module

FIG. 6 is a flow chart illustrating logical processing steps for setting up an electronic auction by pooling consumers of similar or like product or service preferences for advertising according to the Invention.

The Inventions flow charts illustrated in FIG. 2 and FIG. 6 are the embodiments of the Invention shopping or yellow (Y) status mode.

As represented by FIG. 2, in this consumer pooling module (FIG. 6), the Invention electronically pools or aggregates all consumers who have indicated a shopping or yellow (Y) status mode.

FIG. 6 illustrates the Invention pooling various consumers with various personal buying preferences. These buying preferences are representative of general or broad product or service preferences. In the flowchart, various consumers (identified by a consumer #) are identified with their broad buying preferences and are illustrated as consumer #1—travel, consumer #200—shoes, consumer # 40—insurance, and so forth.

Each “broad” personal buying preference is combined or linked with the consumers' “detailed” buying preferences. These “detailed” buying preference are illustrated in FIG. 12.

FIG. 12 represents the consumer's detailed product preference, in a funnel format, which details at the top of the funnel the consumer's broad product preferences (e.g., shoes) and, as the funnel narrows in width, the consumer's product features and specifics get more defined or specific (e.g., Allen Edmonds shoes).

The Invention can provide a better digital blueprint for the marketplace for the bidding process, using this funnel-based tracking and messaging system. This funnel-based tracking and messaging system enables the marketers to bid at multiples levels of consumers' buying preference information.

A marketer might want to provide certain advertising to the consumer at the top of the funnel or at a broader product preference (e.g., shoes), while also providing different advertising at the “men's dress shoes” level, as illustrated in FIG. 12.

While “consumer #200—shoes” is illustrated in FIG. 6, the detailed information for “consumer #200—shoes” is represented in FIG. 12.

The digital blueprint for “shoes” would resemble an electronic product-tracking and messaging stream like this: Shoes→Men's→Dress→Allen Edmonds.

All this information is stored in the consumer's profile account, allowing the consumer to retrieve and share this information through the Invention's electronic messaging system, instantly, into the marketplace.

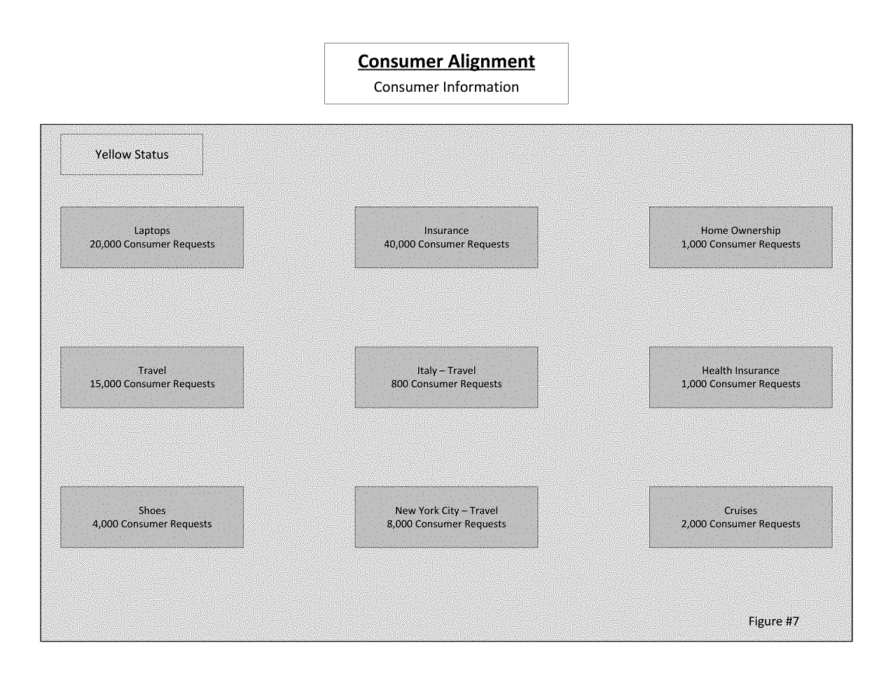

FIG. 7—Consumer Alignment Module

FIG. 7 is a flow chart illustrating logical processing steps for the consumer setting up an electronic auction by aligning consumers (by numerical count) of similar or like product or service preferences for advertising according to the Invention.

The Inventions flow charts illustrated in FIG. 2 and FIG. 7 are the embodiments of the Invention shopping or yellow (Y) status mode.

The consumer-alignment module takes the consumers generated in the consumer-pooling module and aligns consumers with similar personal buying preferences via a numerical count.

As represented by FIG. 2, in this consumer-alignment module (FIG. 7), the Invention electronically aligns all consumers who have indicated a shopping or yellow (Y) status mode, by buying preference, and by numerical count.

The numerical-count aggregation by the Invention enable and empower the consumers to exercise greater aggregate advertising power and strength in the marketplace.

A single consumer requesting advertising in the marketplace by himself/herself would have the advertising power of only one (1) consumer—but the Invention aggregates all consumers with similar or like personal buying preferences to increase their aggregate purchasing power.

For example, the Invention in the consumer-alignment module aligns and prepares the consumer's information so it can notify the marketplace that it has located and secured, say, 500 consumers wanting to see specific advertising for Allen Edmonds shoes, and, say, 20,000 consumers who are specifically requesting advertising for men's dress shoes.

FIG. 7 illustrates the alignment of 40,000 consumers requesting insurance, 1,000 consumers requesting home ownership, 2,000 consumers requesting cruises, etc.

FIG. 7 also represents the alignment and tracking of various personal buying preferences for the marketplace and is electronically forwarded to the marketer-sharing module.

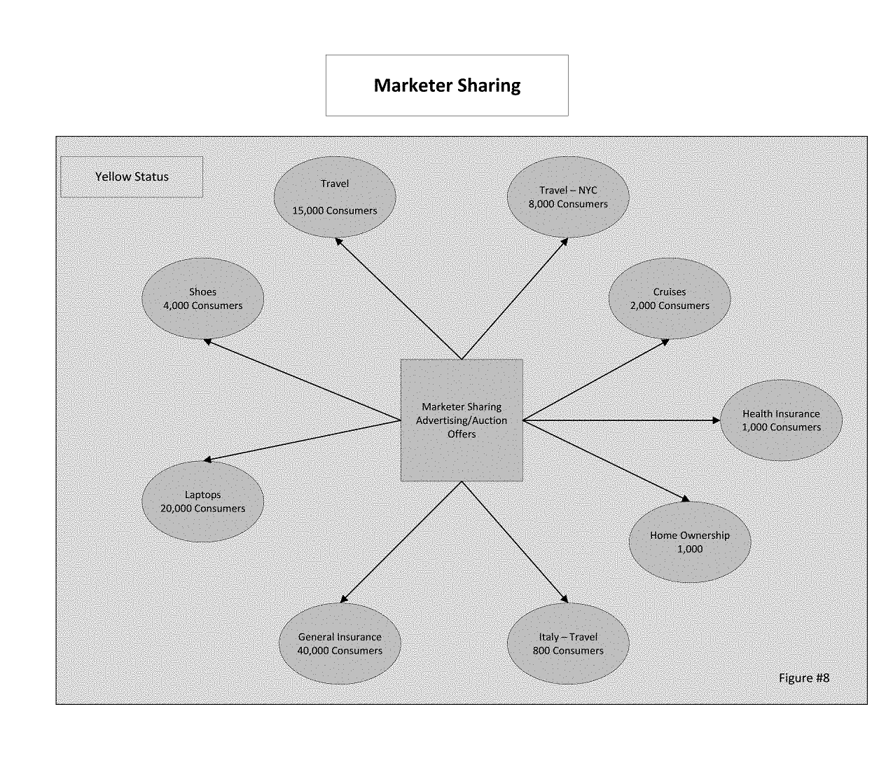

FIG. 8—Marketer Sharing Module

FIG. 8 is a flow chart illustrating logical processing steps for setting up an electronic auction by aligning consumers (by numerical count) of similar or like product or service preferences to be openly shared with the marketplace according to the Invention.

The Inventions flow charts illustrated in FIG. 2 and FIG. 8 are the embodiments of the Invention shopping or yellow (Y) status mode.

The marketer sharing module takes the consumers generated in the consumer alignment module with similar personal buying preferences via a numerical count and electronically shares these consumer-buying preferences in the marketplace.

As represented by FIG. 2, in this marketer sharing module (FIG. 8), the Invention electronically aligns all consumers who have indicated a shopping or yellow (Y) status mode, by buying preference, and by numerical count.

The numerical count aggregation by the Invention enables and empowers the consumers to exercise greater aggregate advertising power and strength in the marketplace.

The marketer sharing module is responsible for messaging the marketplace that the consumer is interested in receiving CTR bids.

Marketers will use this information to formulate their CTR bids.

FIG. 2—Advertising Bid Module (Marketer Response)

After the consumers' buying preferences have been released and shared into the marketplace, marketers will submit their CTR bids to determine where their advertising is positioned vis-a-vis other marketers.

Advertisements will be positioned to the consumer based on the CTR bids, highest to lowest.

For example, if marketer “A” is the highest marketer bidder at a CTR price of $7.50 and marketer “B” is the lowest marketer bidder at a CTR price of $0.10, and there are fifty (50) other marketer bidders in between these bids, marketer “A's” advertisement would be positioned at the top of the advertising consumer's bid module screen.

Correspondingly, marketer “B's” advertisement would be positioned at the bottom of the advertising bid module screen, while the 50 other marketer bidders' CTR bids would be positioned between the high and low CTR bids, and rank-ordered in descending order, based on their CTR pricing bids.

If the consumer clicks on marketer “A's” advertisement, at the time the advertisement is opened and displayed on the consumer's screen, marketer “A” would pay the Invention a CTR price of $7.50.

If the consumer saves marketer “A's” advertisement, based on the save through rate (STR) in his/her consumer profile account, the marketer would pay a percentage (%) of the CTR price of $7.50 each time the consumer saves the advertisements in his/her consumer profile account.

Upon receiving marketer advertising bids, the consumer also has other decision options.

If consumers do not open or delete advertising, marketers will not pay a CTR fee to the Invention for any unopened or deleted advertisements. Consumers can also request the marketer for more advertising information.

Advertisements saved to the consumer-profile account are the most valued advertisements by the marketers. Saved advertisements from the shopping or yellow (Y) status mode are just a click away from being changed to a buying or green (G) status mode.

Saved advertisements are the most likely advertisements to generate future buying offers from the consumers to the marketers.

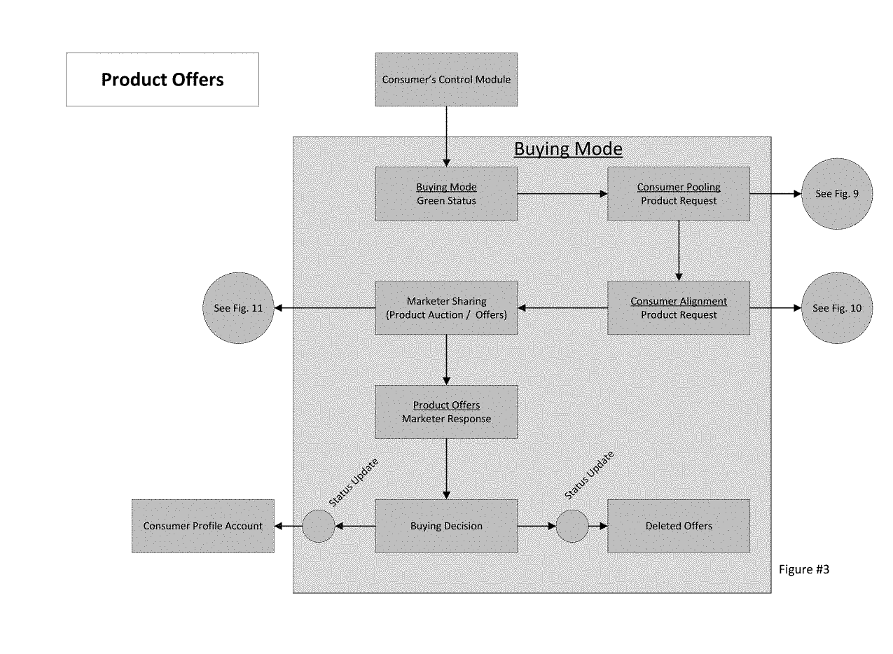

FIG. 3—Buying or Green (G) Status Mode

In the buying or green (G) status mode, the consumer indicates when he/she is now interested in purchasing his/her desired buying preference.

The Invention provides the electronic permission to the marketplace that the consumer wants to now purchase specific personal buying preference items from this/her preference dream or bucket list.

In the buying or green (G) status mode, the consumer will begin to receive requested or wanted product or service offers from marketers.

Once the consumer electronically sets a buying or green (G) status mode, that consumer information is electronically sent to the Invention's consumer pooling module.

The buying or green (G) status mode is substantially like the shopping or yellow (Y) status mode in its processes and procedures. Both transaction modes interface electronically in the same way with the marketplace. Both transaction modes track and message by requesting the marketers to respond to information the consumer has released into the marketplace.

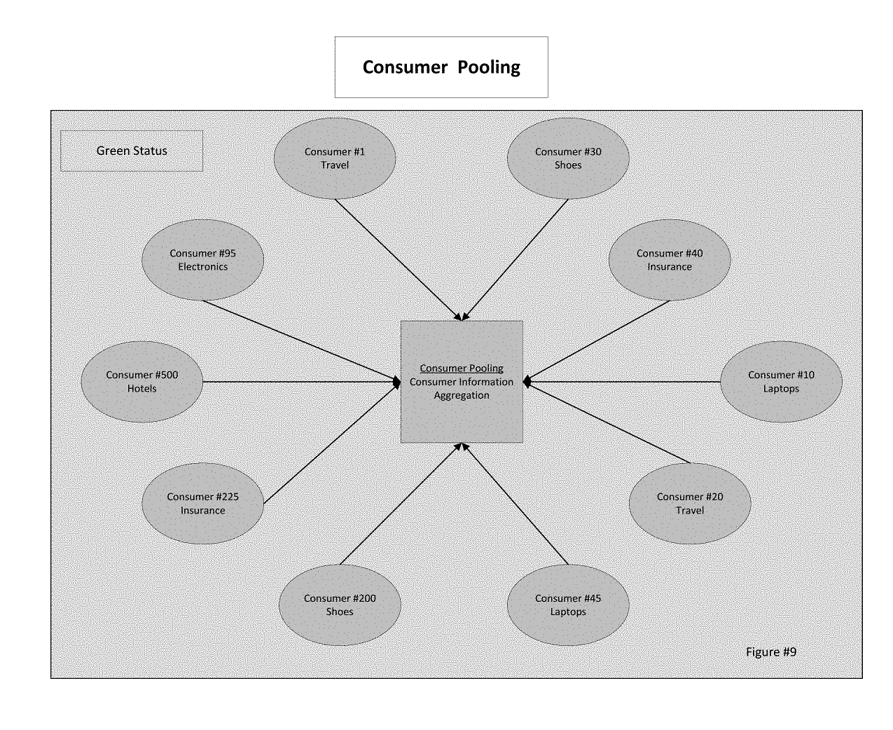

FIG. 9—Consumer Pooling Module (Buying or Green (G) Status Mode)

FIG. 9 is a flow chart illustrating logical processing steps for the consumers setting up an electronic auction by pooling consumers of similar or like product or service preferences for marketplace “offers” according to the Invention.

The Inventions flow charts illustrated in FIG. 3 and FIG. 9 are the embodiments of the Invention buying or green (G) status mode.

As represented by FIG. 3, in this consumer pooling module (FIG. 9), the Invention electronically pools or aggregates all consumers who have indicated a buying or green (G) status mode for a personal buying preference product or service.

FIG. 9 illustrates the Invention pooling various consumers with various personal buying preferences who are now requesting to see product or service offers from marketers. These buying preference requests are representative of general or broad product or service preferences. In the flowchart, various consumers (identified by a consumer #) are identified with their broad buying preferences, and are illustrated as consumer #1—travel, consumer #200—shoes, consumer # 40—insurance, and so forth.

Each “broad” personal buying preference is combined or linked with the consumer's “detailed” buying preferences. These “detailed” buying preferences are illustrated in FIG. 13.

FIG. 13 represents the consumer's detailed product preference, in a funnel format, which details at the top of the funnel the consumer's broad product preferences (e.g., shoes) and, as the funnel narrows in width (towards the bottom of the funnel), the consumer's product features and specifics get more defined (e.g., Allen Edmonds shoes).

The Invention provides a better digital blueprint for the marketplace for the bidding process, using this funnel-based tracking and messaging system. This funnel-based tracking and messaging system allows the marketers to bid at multiple levels of consumers' buying preference information.

Consumers at the bottom of the funnel are more likely to purchase, since these consumers have better defined their purchasing requirements. This information enables the marketers to better profile their offers to the consumers' detailed needs and requests.

A marketer might want to provide certain offers to the consumer at the top of the funnel or broader product preference (e.g., shoes), while also providing different offers at the narrower part of the funnel or more specific product preference (e.g., “men's dress shoes”), as illustrated in FIG. 13.

While “consumer #200—shoes” is illustrated in FIG. 8, the detailed information for “consumer #200—shoes” is represented by FIG. 13.

The digital blueprint for “shoes” would resemble an electronic product tracking and messaging stream like this: Shoes→Men's→Dress→Allen Edmonds.

All this information is stored in the consumer's profile account, allowing the consumer to retrieve and share this information through the Invention's electronic messaging system, instantly, into the marketplace.

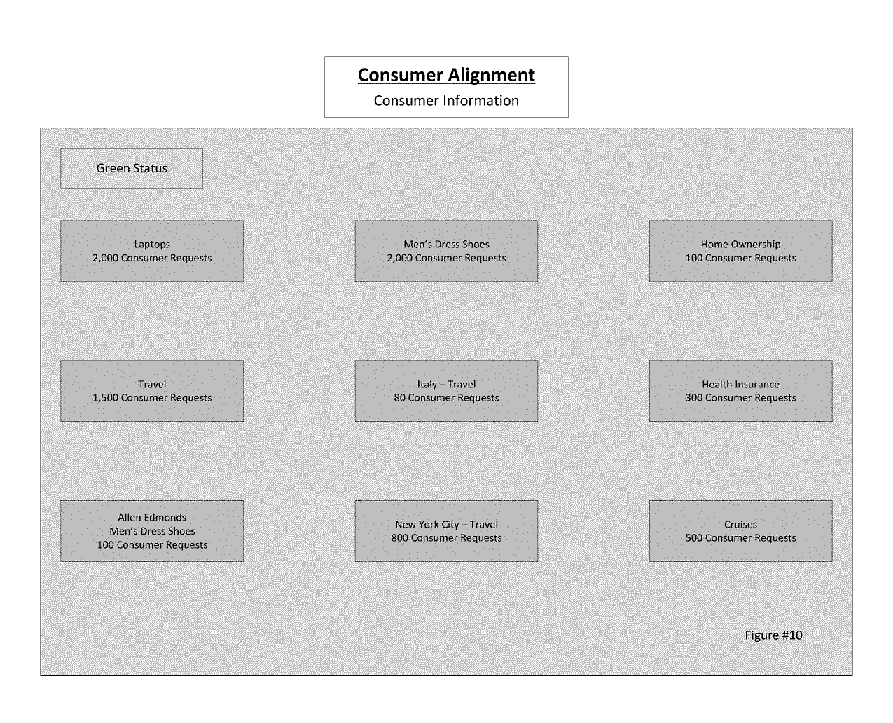

FIG. 10—Consumer Alignment Module (Buying or Green (G) Status Mode)

FIG. 10 is a flow chart illustrating logical processing steps for the consumer setting up an electronic auction by aligning consumers (by numerical count) of similar or like product or service preferences for marketplace “offers” according to the Invention.

The Inventions flow charts illustrated in FIG. 3 and FIG. 10 are the embodiments of the Invention buying or green (G) status mode.

The consumer-alignment module takes the consumers generated in the consumer-pooling module and aligns all consumers with similar personal buying preferences via a numerical count.

As represented by FIG. 3, in this consumer-alignment module (FIG. 10), the Invention electronically aligns all consumers who have indicated a buying or green (G) status mode, by buying preference, and by numerical count.

The numerical-count aggregation by the Invention enables and empowers the consumers to exercise greater aggregate purchasing power and strength in the marketplace.

A single consumer requesting product offers in the marketplace by himself/herself would have the purchasing power of only one (1) consumer, but the Invention aggregates consumers in hundreds and thousands to increase the consumers' aggregate purchasing power.

Marketers are more likely to provide better prices or bids to a group of consumers looking to purchase 1,000 products versus only 1 product.

For example, the Invention in the consumer-alignment module aligns and prepares the product or service information so it can notify the marketplace that it has located and secured, say, 100 consumers now wanting to purchase Allen Edmonds shoes, and, say, 2,000 consumers now wanting to purchase men's dress shoes.

FIG. 10 illustrates the alignment of 80 consumers requesting travel to Italy, 500 consumers requesting a cruise, 300 consumers requesting health insurances, etc.

FIG. 10 also represents the alignment and tracking of various personal buying preferences for the marketplace and are electronically forwarded to the marketer-sharing module.

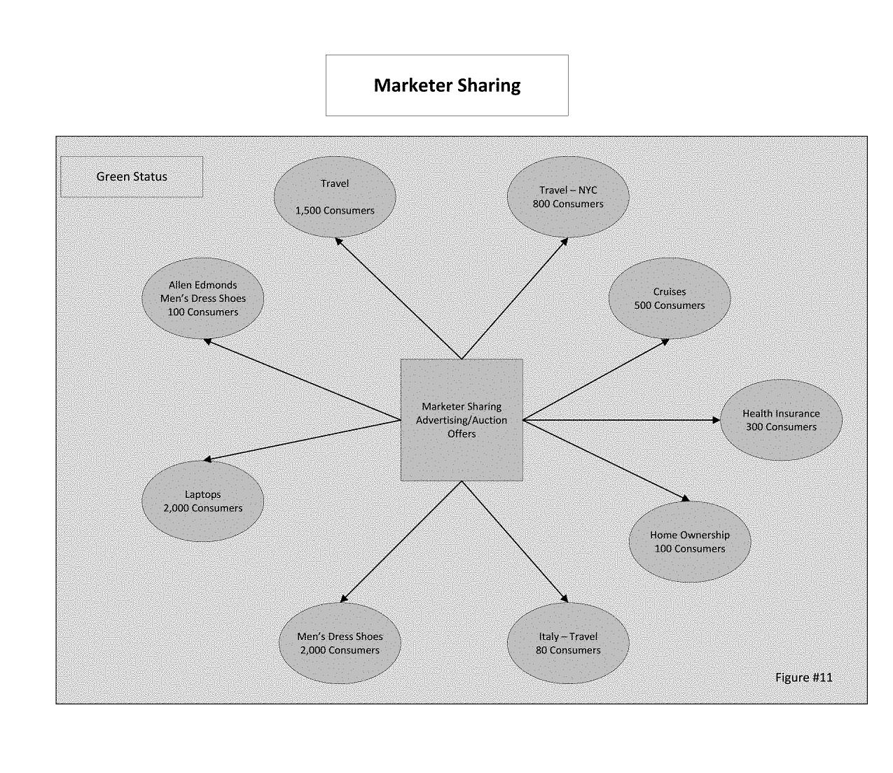

FIG. 11—Marketer Sharing Module (Buying or Green (G) Status Mode)

FIG. 11 is a flow chart illustrating logical processing steps for the consumer setting up an electronic auction by aligning consumers (by numerical count) of similar or like personal buying product or service preferences to openly share and request “offers” from the marketplace according to the Invention.

The Invention flow charts illustrated in FIG. 3 and FIG. 11 are the embodiments of the Invention buying or green (G) status mode.

The marketer-sharing module takes the consumers generated in the consumer-alignment module with similar personal buying preferences via a numerical count and electronically shares these consumer-buying preferences in the marketplace.

As represented by FIG. 3, in this marketer-sharing module (FIG. 11), the Invention electronically aligns all consumers who have indicated a buying or green (G) status mode, by buying preference, and by numerical count.

The numerical-count aggregation by the Invention enables and empowers the consumers to exercise greater aggregate purchasing power and strength in the marketplace.

The marketer-sharing module is responsible for messaging the marketplace that the consumer is now ready to purchase products or services and is interested in receiving marketers' product or service offers or bids.

Marketers will use this information to formulate their specific product or service offers or bids to this consumer (and other consumers with similar personal buying preferences).

FIG. 3—Product Offer Module—Marketer Response (Buying or Green (G) Status Mode)

After the consumers' buying preferences have been released and shared into the marketplace, marketers will submit their offers or bids to determine where their offers are positioned vis-a-vis other marketers.

Offers will be positioned to the consumers based on the best offers, lowest to highest, and the offers that best align with the consumers' requests.

For example, marketers wanting to bid on the 100 consumers wanting to purchase Allen Edmonds shoes are illustrated below.

If marketer “A” provides the best offer (or lowest price) to the 100 consumers wanting to purchase Allen Edmonds shoes at $800 per pair and marketer “B” has the worst/most expensive offer (or highest price) at $1,200 per pair, and there are five (5) other bidders in between these price offers, marketer “A's” product offer will be positioned at the top of the consumers' product offer module screens.

Correspondingly, marketer “B's” product offer would be positioned at the bottom of the consumers' product offer module screens, while the 5 other marketer bidder offers would be positioned between the lowest and highest price offers, and rank-ordered based on their offer pricing, in descending order, from lowest to highest.

FIG. 3—Buying Decision Module—(Buying or Green (G) Status Mode)

As illustrated in FIG. 3, at the buying-decision module, the consumer has a buying decision once the product offers are submitted. Marketers' offers will be time-sensitive and limited for various periods of time, and will terminate at their expiration.

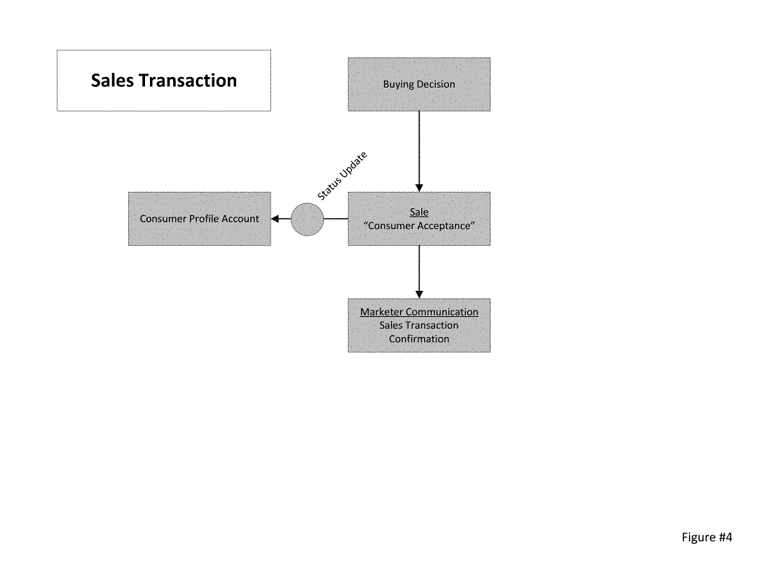

The Invention allows the consumer at the buying-decision module to (i) delete offers presented, (ii) change their buying or green (G) status mode to another status mode (e.g., privacy or red (R) status mode, or shopping or yellow (Y) status mode) and update the consumer-profile account, and (iii) proceed to the sales module, as per FIG. 4. At the sales module, the sales transaction is completed.

FIG. 4—Sales Module—(Consumer Acceptance)

At the sales module, the sales transaction is confirmed and the transaction requirements are communicated accordingly to the consumer.

A sales transaction may occur in several ways.

Marketer may send a coupon to consumer for use in retail or online stores. If the consumer uses the coupon, this transaction would occur outside of the Invention.

In a coupon-based sales transaction, the Invention will follow up with the consumer to confirm where and when the consumer used the marketer's winning-offer coupon, and the consumer-profile account updated accordingly.

If the coupon was not used, the Invention would try to capture the reasons the consumer did not purchase the product or service.

Consumer may purchase the product or service through the Invention. Embedded in the marketer's offer will be an electronic link to purchase the product or service directly through a buying-interface application on the internet.

The consumer fills out an electronic web form, using default information stored in his/her consumer-profile account (shipping and billing addresses, credit or debit card information, etc.) to make the purchase-transaction process as simple as possible.

Consumers can override default information electronically, as desired or necessary.

Once all consumer-transaction purchase information is complete, the Invention will electronically forward the information to the marketer.

Marketer will then electronically send confirmation to the consumer.

The Invention electronically updates the consumer-profile account for electronic historical records and tracking.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. An apparatus and method for a computer implemented advertising system comprising in combination:
having an online user label an online product with a color; and
outputting the product with the color to a display device, storage medium or network.

2. The method as described in claim 1 wherein the color is red, green or yellow.

3. The method as described in claim 1 wherein the color represents the user's preference.

4. An apparatus and method for a computer implemented advertising system comprising in combination:
having an online user label an online product with a color;
having the user input identifying information; and
outputting the product with the color to a display device, storage medium or network.

5. The method as described in claim 4 wherein the color is red, green or yellow.

6. The method as described in claim 4 wherein the color represents the user's preference.

7. An apparatus and method for a computer implemented advertising system comprising in combination:
having an online user label an online product with a color;
having the user input identifying information;
having the user input a buying preference; and
outputting the product with the color to a display device, storage medium or network.

8. The method as described in claim 7 wherein the color is red, green or yellow.

9. The method as described in claim 7 wherein the color represents the user's preference.
